(19) United States
(12) Patent Application Publication
(10) Pub. No.: US 2026/0094314 A1
(43) Pub. Date: Apr. 2, 2026

(54) INFORMATION PROCESSING SYSTEM, INFORMATION PROCESSING METHOD, AND STORAGE MEDIUM

(71) Applicant: HONDA MOTOR CO., LTD., Tokyo (JP)

(72) Inventors: Yuta Nishizawa, Tokyo (JP); Junichiro Onaka, Tokyo (JP); Kenta Maruyama, Tokyo (JP); Yusuke Ishida, Tokyo (JP)

(21) Appl. No.: 19/339,354

(22) Filed: Sep. 25, 2025

(30) Foreign Application Priority Data
Sep. 30, 2024 (JP) 2024-170453

(51) Int. Cl. G06T 11/00; G06V 20/20; G06V 20/58

(52) U.S. Cl. CPC G06T 11/00; G06V 20/20; G06V 20/58

(57) ABSTRACT

An information processing system includes a first device mounted on a mobile body and a second device configured to communicate with the first device. The first device captures an image of scenery around the mobile body, extracts a first object from the captured image of the scenery, and transmits the first object to the second device. The second device receives the first object transmitted from the first device, reads the second object from a storage unit in which the second object is stored in advance, and generates a superimposed image that is an image in which the first object is superimposed on the read second object.

### CROSS-REFERENCE TO RELATED APPLICATION

This application is based upon and claims the benefit of priority from Japanese Patent Application No. 2024-170453, filed September 30, 2024, the entire content of which is incorporated herein by reference.

### BACKGROUND

### Field of the Invention

The present invention relates to an information processing system, an information processing method, and a storage medium.

### Description of Related Art

Technology for superimposing a virtual object (a historical scenery, digital signage, an aurora, a constellation, or the like) on a part of an image of scenery when the image of the scenery seen from a vehicle is displayed on a display is known (see, for example, PCT International Publication No. WO/2012/033095).

### SUMMARY

However, in the conventional technology, image quality may be degraded or communication may be delayed due to an image data capacity, a communication speed, or the like.

In order to solve the above problem, an objective of the present application is to provide an information processing system, an information processing method, and a storage medium that can provide a user with a low-latency, high-quality image. Also, the sense of immersion, satisfaction, and realism of the user who sees the image or the like is improved. By extension, suitable connections between urban areas and rural areas including peri-urban areas are supported and new activities created.

An information processing system, an information processing method, and a storage medium according to the present invention adopt the following configurations.

(1) According to a first aspect of the present invention, there is provided an information processing system including: a first device mounted on a mobile body; and a second device configured to communicate with the first device, wherein the first device includes a camera configured to capture an image of scenery around the mobile body, an extraction unit configured to extract a first object, which is at least one of a dynamic object and a static object, from the image of the scenery captured by the camera, and a transmission unit configured to transmit the first object to the second device, and wherein the second device includes a reception unit configured to receive the first object transmitted from the first device, and a generation unit configured to read the second object, which is the other of the dynamic object and the static object that is not the first object, from a storage unit in which the second object is stored in advance and generate a superimposed image that is an image in which the first object is superimposed on the read second object.

(2) According to a second aspect of the present invention, in the first aspect, a previously captured image of the scenery is included in the image from which the first object is extracted.

(3) According to a third aspect of the present invention, in the first or second aspect, a three-dimensional map image provided by a three-dimensional map service is included in the image from which the first object is extracted.

(4) According to a fourth aspect of the present invention, in the first or second aspect, the information processing system further includes a third device configured to communicate with the second device, wherein the third device has an input interface operated by a user, and wherein the extraction unit extracts one of the dynamic object and the static object selected by the user via the input interface as the first object from the image.

(5) According to a fifth aspect of the present invention, in the first or second aspect, the generation unit generates an image in which a third object is superimposed on the read second object as the superimposed image, and a fictional object, an object captured at a location different from the scenery, or an object extracted from a previously captured image of the scenery is included in the third object.

(6) According to a sixth aspect of the present invention, there is provided an information processing method using an information processing system including a first device mounted on a mobile body and a second device configured to communicate with the first device, the information processing method including: capturing, by the first device, an image of the scenery around the mobile body; extracting, by the first device, a first object, which is at least one of a dynamic object and a static object, from the captured image of the scenery; transmitting, by the first device, the first object to the second device; receiving, by the second device, the first object transmitted from the first device; reading, by the second device, a second object, which is the other of the dynamic object and the static object that is not the first object, from a storage unit in which the second object is stored in advance; and generating, by the second device, a superimposed image that is an image in which the first object is superimposed on the read second object.

(7) According to a seventh aspect of the present invention, there is provided a non-transitory storage medium storing a program to be executed by a computer of each of a first device mounted on a mobile body and a second device configured to communicate with the first device, wherein the program includes capturing an image of the scenery around the mobile body; extracting a first object, which is at least one of a dynamic object and a static object, from the captured image of the scenery; transmitting the first object to the second device; receiving the first object transmitted from the first device; reading a second object, which is the other of the dynamic object and the static object that is not the first object, from a storage unit in which the second object is stored in advance; and generating a superimposed image that an image in which the first object is superimposed on the read second object.

According to the above aspect, it is possible to provide a user with a low-latency, high-quality image. As a result, it is possible to improve the sense of immersion, satisfaction, and realism and the like.

### BRIEF DESCRIPTION OF THE DRAWINGS

FIG. 1 is a diagram showing an example of a configuration of an information processing system according to an embodiment.

FIG. 2 is a diagram showing an example of user data.

FIG. 3 is a diagram showing an example of a static object predetermined for each coordinate.

FIG. 4 is a diagram showing an example of a configuration of a mobile device according to an embodiment.

FIG. 5 is a diagram showing an example of an arrangement of a part of a mobile device in a mobile body according to the embodiment.

FIG. 6 is a diagram showing an example of a configuration of a user device according to an embodiment.

FIG. 7 is an explanatory diagram of an image corresponding to an orientation direction.

FIG. 8 is a sequence diagram showing a series of processing steps of an information processing system according to an embodiment.

FIG. 9 is a diagram showing an example of a scenery image.

FIG. 10 is a diagram showing an example of a dynamic object.

FIG. 11 is a diagram showing an example of a static object.

### DESCRIPTION OF EMBODIMENTS

Hereinafter, embodiments of an information processing system, an information processing method, and a storage medium according to the present invention will be described with reference to the drawings.

### Configuration of information processing system and configuration of information processing device

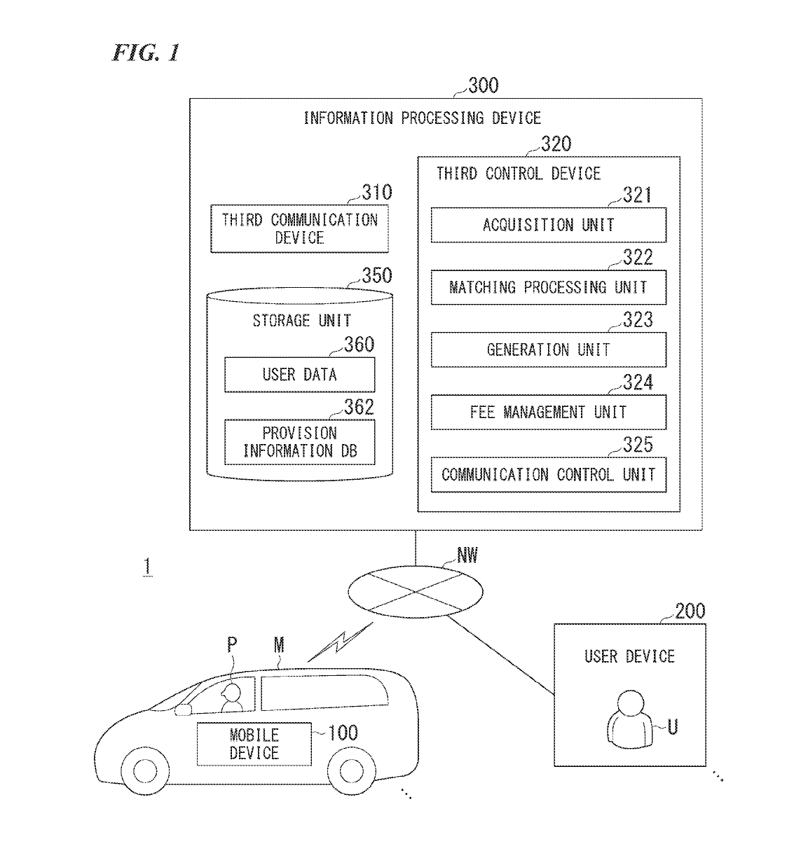

FIG. 1 is a diagram showing an example of the configuration of an information processing system 1 according to an embodiment. The information processing system 1 includes a mobile device 100, a user device 200, and an information processing device 300.

The mobile device 100 is mounted on a mobile body M boarded by an occupant P. The mobile body M is typically a vehicle, but may be any mobile body (e.g., a watercraft or an aircraft) capable of being boarded by the occupant P. Moreover, the occupant P is primarily a driver of the mobile body, but may also be an occupant other than the driver (e.g., a fellow passenger in a passenger seat). The mobile device 100 is an example of a “first device.”

The user device 200 is used by a user U at a location different from that of the mobile body M (a location that happens to be close is not excluded). The user device 200 is an example of a “third device.”

Between the mobile device 100 and the user device 200, the voice collected by the microphone is transmitted to the other party and reproduced by a speaker. Thereby, a telephone conversation between the occupant P and the user U is performed. Furthermore, a part of an image captured by a camera unit of the mobile device 100 is displayed on the user device 200. Thereby, mixed reality (MR) is provided to the user device 200, and the user U can obtain a feeling that he or she is boarding the mobile body M in a pseudo way while being in a different place from that of the mobile body M (pseudo-boarding experience). Furthermore, by talking with the user U who is experiencing pseudo-boarding on the mobile body M via the mobile device 100, the occupant P can obtain a feeling that the user U is actually boarding the mobile body M with him or her. Hereinafter, the pseudo-experience of the user U actually boarding the mobile body M may be referred to as “pseudo-boarding.” The mobile device 100 and the user device 200 do not need to have a one-to-one relationship, and one of a plurality of mobile devices 100 and a plurality of user devices 200 may have a one-to-many relationship to operate as the information processing system 1. In the latter case, for example, one occupant P can communicate with a plurality of users U simultaneously or sequentially.

The mobile device 100, the user device 200, and the information processing device 300 communicate with one another via a network NW. The network NW, for example, includes at least one of the Internet, a wide area network (WAN), a local area network (LAN), a mobile communication network, a cellular network, and the like. The information processing device 300 may be implemented in a server device or a storage device incorporated in a cloud computing system. In this case, the functions of the information processing device 300 may be implemented by a plurality of server devices or storage devices in the cloud computing system. Moreover, the mobile device 100 mounted on the mobile body M may be implemented its functions by cooperating with the mobile device 100 mounted on another mobile body.

The information processing device 300 processes information provided from the mobile device 100 to the user device 200 and information provided from the user device 200 to the mobile device 100. The information processing device 300 is an example of a “second device.”

As shown in FIG. 1, the information processing device 300 includes, for example, a third communication device 310, a third control device 320, and a storage unit 350.

The third control device 320 includes an acquisition unit 321, a matching processing unit 322, a generation unit 323, a fee management unit 324, and a communication control unit 325. These constituent elements are implemented, for example, by a hardware processor such as a central processing unit (CPU) executing a program (software). Some or all of these constituent elements may be implemented by hardware (including a circuit unit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The above-described program may be pre-stored in a storage device (a storage device including a non-transitory storage medium) such as a hard disk drive (HDD) or a flash memory or may be stored in a removable storage medium (a non-transitory storage medium) such as a DVD or a CD-ROM and installed when the storage medium is attached to a drive device. The program may be updated as appropriate via the network NW.

The third communication device 310 is a communication interface for connecting to the network NW. The communication between the third communication device 310 and the mobile device 100, and the communication between the third communication device 310 and the user device 200 may be performed in accordance with a transmission control protocol/internet protocol (TCP/IP). The third communication device 310 is an example of a “reception unit.”

The acquisition unit 321 acquires various types of information from the mobile device 100, the user device 200, or other external devices via the third communication device 310.

The matching processing unit 322, for example, is implemented by a processor such as a CPU executing a program (a group of instructions) stored in a storage medium. For example, when the third communication device 310 receives a matching request from the user U via the user device 200 or from the occupant P via the mobile device 100, the matching processing unit 322 performs matching between the matching user U and the occupant P with reference to the user data 360, transmits communication identification information of the mobile device 100 of the occupant P to the user device 200 of the matched user U using the third communication device 310, and transmits communication identification information of the user device 200 of the user U to the mobile device 100 of the matched occupant P. Communication with better real-time properties can be executed between the mobile device 100 and the user device 200 that have received the communication identification information, for example, in accordance with a user datagram protocol (UDP).

The generation unit 323 generates information to be provided to each of the mobile device 100 and the user device 200 on the basis of the various types of information acquired by the acquisition unit 321, generates information indicating a processing result of the matching processing unit 322, and generates information indicating fee information (settlement information) managed by the fee management unit 324.

The fee management unit 324 manages a fee to be charged to the user U in accordance with the information provided to the user U and a fee to be charged to the occupant P in accordance with the information provided to the occupant P of the mobile body M. Moreover, the fee management unit 324, for example, may manage the compensation to be paid to the user U and the occupant P in accordance with information provided from the user U and the occupant P. Moreover, the fee management unit 324 may perform a process related to the settlement of the user U and the occupant P.

The communication control unit 325 transmits various types of information (e.g., superimposed images and the like) generated by the generation unit 323 to the mobile device 100 or the user device 200 via the third communication device 310.

The storage unit 350 may be implemented by the various types of storage devices described above, or a solid-state drive (SSD), an electrically erasable programmable read only memory (EEPROM), a read only memory (ROM), or a random-access memory (RAM). The storage unit 350, for example, may store a program executed by a CPU or the like, user data 360, a provision information DB 362, and the like.

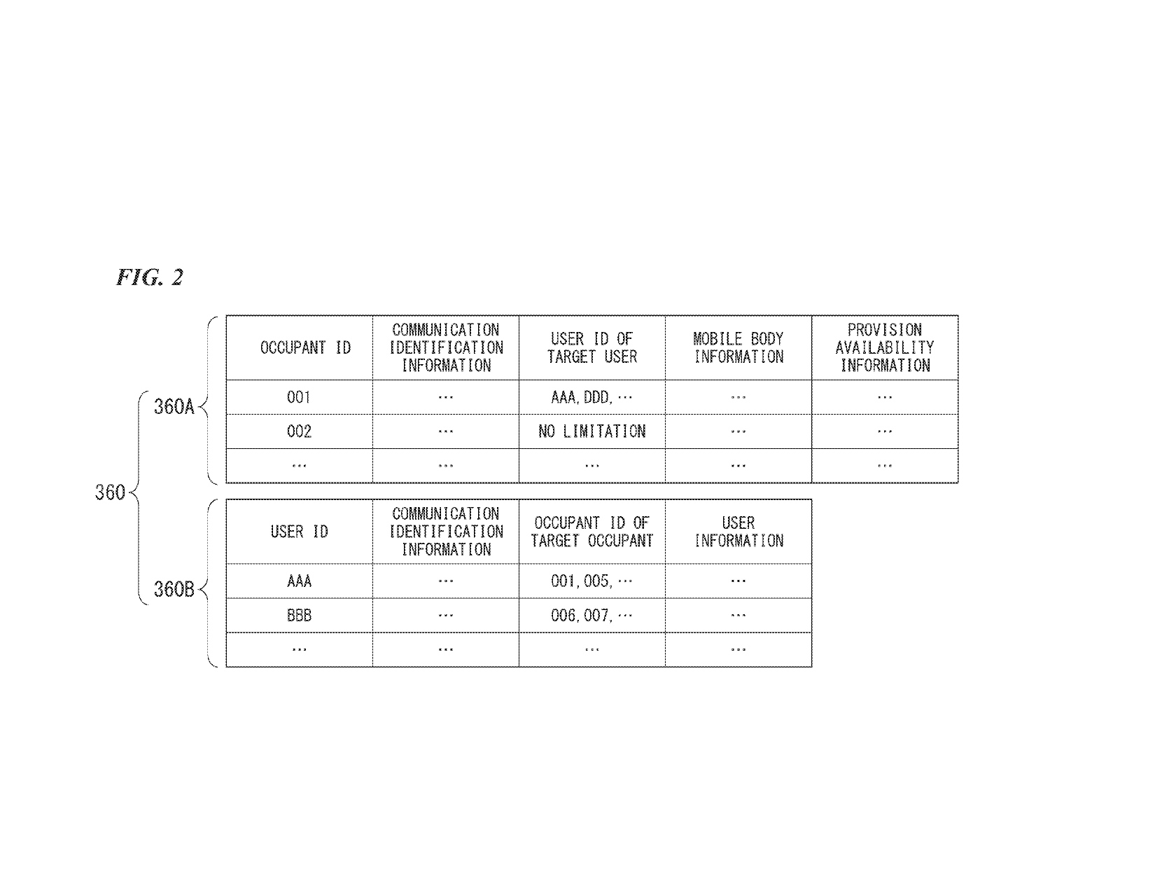

FIG. 2 shows an example of the user data 360. The user data 360 includes an occupant list 360A and a user list 360B. In the occupant list 360A, for example, an occupant ID, which is identification information of the occupant P of the mobile body M, its communication identification information (an IP address or the like), a user ID, which is identification information of the user U serving as a matching target, information of a mobile body boarded by the occupant, and provision availability information set by the occupant are associated with one another. The mobile body information includes, for example, information about equipment mounted on the mobile body M (mounted equipment information) and vehicle class information indicating a size and external shape of the mobile body M. Moreover, the mobile body information may include information about a current position, a destination, and a surrounding situation (e.g., during traveling on a seaside road) of the mobile body M transmitted from the mobile body M at a predetermined interval. In the user list 360B, for example, a user ID, its communication identification information (an IP address or the like), an occupant P serving as a matching target, and user information are associated with one another. The user information may include information about physical build (e.g., a height and a sitting height), information for predicting physical build (e.g., age), and the like. The provision availability information is information that can be provided or cannot be provided by the mobile body M, and is set, for example, by the occupant P. The provision permission information may be set for each device mounted on the mobile body M, or may be set for each user U. Examples of the provision permission information include, but are not limited to, “image provision is permitted,” “sound provision is not permitted,” “indoor image provision is permitted but outdoor image provision not permitted,” “occupant image provision is not permitted,” “the use of a navigation device is not permitted,” and the like. Moreover, the provision permission information may include a fee (a service provision fee) for enabling the provision. The user data 360 may be generated in any aspect, not limited to the aspect shown in FIG. 2, as long as it includes this information.

The provision information DB 362 stores various types of information to be provided to the user U or the occupant P. The various types of information include, for example, map information, point of interest (POI) information, and images drawn by computer processing (e.g., computer graphics (CG) images of people and images of marks, symbols, icons, and the like). The POI information is, for example, information about various types of stores, theme parks, terrestrial objects, and the like at each location, and may be included in the map information. Moreover, the various types of information may include sound information. The provision information DB 362 may include advertising information. The advertising information may include, for example, advertising related to the mobile body M, advertising related to the user U or the occupant P, and advertising related to products and services of stores. In addition, the inserted advertising information is managed separately from indoor and outdoor information. Subsequently, when the inserted advertising information is archived and distributed later, it may be different from inserted advertising information when distributed in real time (e.g., a closed store is replaced with the latest information, the menu introduced will be the latest information, and the like). The advertising information is, for example, a video or audio.

The provision information DB 362 may include static objects OBs that are predetermined for each coordinate as map information or POI information. The static objects OBs are objects that are relatively immovable with respect to a road on which the mobile body M travels (in other words, objects that are fixed to its location), and may include, for example, bridges, buildings, mountains, trees, tunnels, houses, traffic lights, street lights, utility poles, guardrails, soundproof walls, and the like.

In contrast, dynamic objects OBd, which will be described below, are objects that are movable relative to the road on which the mobile body M travels (in other words, objects that are not fixed to its location), and may include, for example, pedestrians, other mobile bodies, animals such as dogs and cats, clouds floating in the sky, waves on a sea surface, and the like.

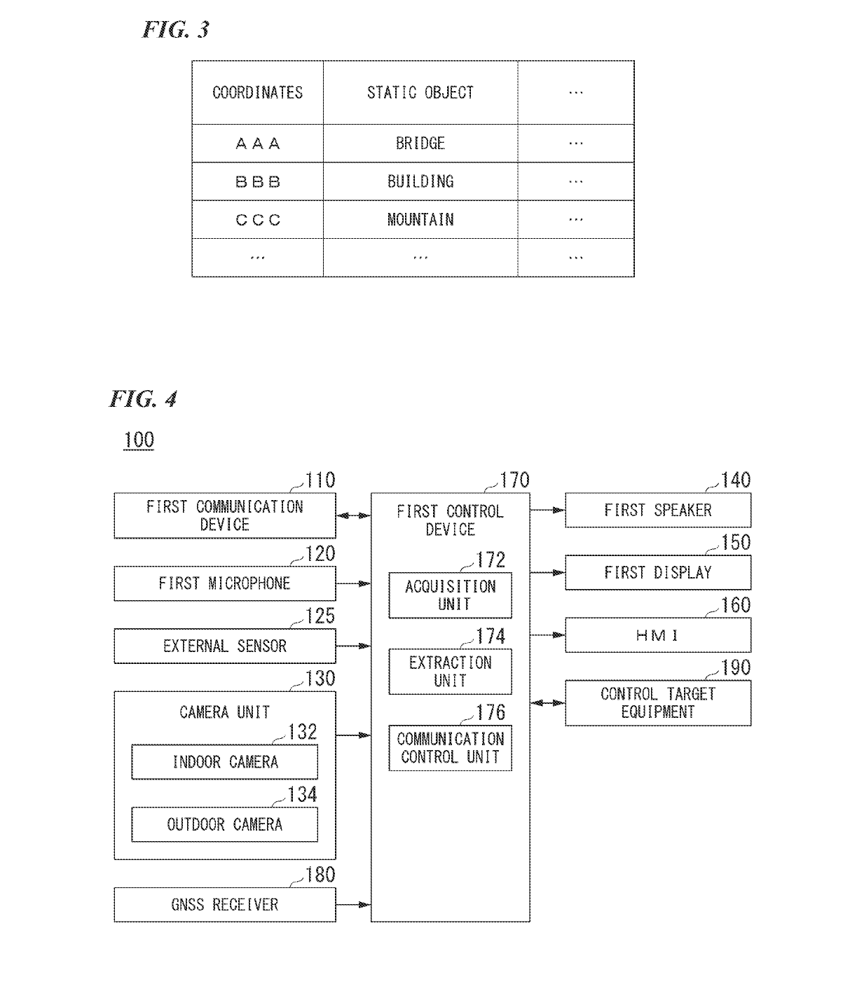

FIG. 3 is a diagram showing an example of static objects OBs that are predetermined for each coordinate. For example, coordinates of a location where a bridge exists are associated with the bridge, towers associated with the bridge, main cables, hanger ropes, and the like as the static objects OBs. Moreover, office buildings and the like are associated with coordinates of an office district as the static objects OBs.

### Configuration of mobile device

FIG. 4 is a diagram showing an example of a configuration of the mobile device 100 according to an embodiment. The mobile device 100 includes, for example, a first communication device 110, a first microphone 120, an external sensor 125, a camera unit 130, a first speaker 140, a first display 150, a human-machine interface (HMI) 160, a first control device 170, and a global navigation satellite system (GNSS) receiver 180. The first control device 170 is connected to a control target equipment 190 mounted on the mobile body M.

The first communication device 110 is a communication interface for communicating with each of a third communication device 310 of the information processing device 300 and a second communication device 210 of the user device 200 to be described below via the network NW. The first communication device 110 is an example of a “transmission unit.”

The first microphone 120 collects at least voice uttered by the occupant P. The first microphone 120 may be provided inside the mobile body M and may have a sensitivity capable of collecting sounds outside the mobile body M, or may include a microphone provided inside the mobile body M and a microphone provided outside the mobile body M. Hereinafter, sound information acquired by the microphone provided inside may be referred to as “indoor sound information.” Sounds collected by the first microphone 120, for example, are transmitted to the information processing device 300 or the user device 200 by the first communication device 110 via the first control device 170. Moreover, when it is not possible to set a microphone provided outside the mobile body M, the indoor sound information may be processed to generate outdoor sound information in a pseudo way on the basis of travel information (a vehicle speed, acceleration/deceleration, road vibration, and) and a surrounding travel environment. Moreover, a positional relationship of a speaker with respect to the mobile body M (whether the speaker is inside or outside the vehicle) can be recorded, and the collected sound may be processed in accordance with the positional relationship.

The external sensor 125 detects a position of a physical object around the mobile body M. The external sensor 125 is, for example, a radar device, a light detection and ranging (LIDAR) sensor, or any other type of proximity sensor. The radar device emits radio waves such as millimeter waves around the mobile body M and detects radio waves (reflected waves) reflected by the physical object to detect at least a position of the physical object (a distance from the physical object and a direction of the physical object). The radar device may detect the position and speed of the physical object by a frequency modulated continuous wave (FM-CW) method. The LIDAR sensor radiates light (or electromagnetic waves with a wavelength close to that of light) around the mobile body M, measures scattered light, and detects a distance to a target on the basis of time from light emission to light reception. The emitted light is, for example, pulsed laser light. The radar device or LIDAR sensor is attached to any location on the mobile body M. Moreover, the external sensor 125 may detect nearby physical objects using images captured by an outdoor camera 134 of the camera unit 130.

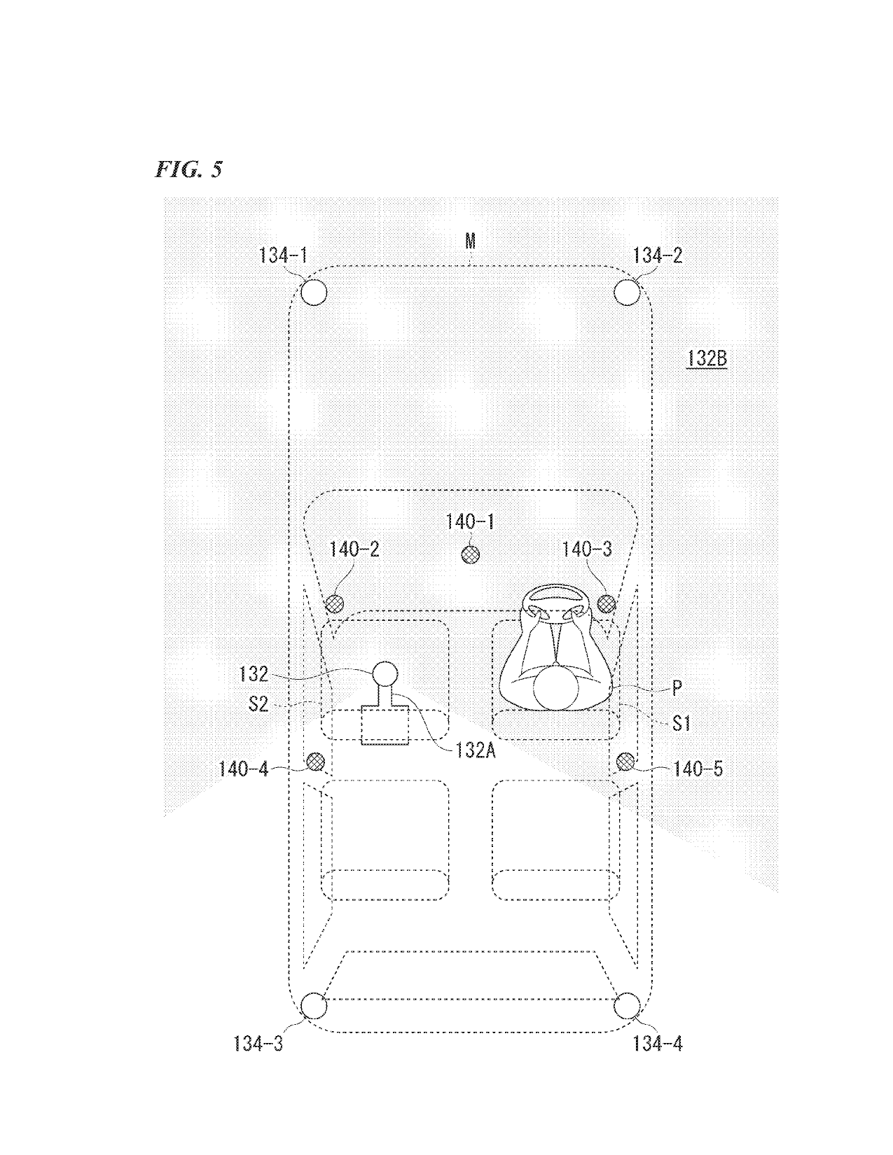

The camera unit 130 includes, for example, an indoor camera 132 and the outdoor camera 134. The first speaker 140 outputs voice of the user U acquired via the first communication device 110. Details of the arrangement of the camera unit 130 and the first speaker 140 will be described below with reference to FIG. 5.

The first display 150 virtually displays the user U as if the user U is present inside the mobile body M. For example, the first display 150 causes a hologram to appear or displays the user U on a part of the mobile body M that corresponds to a mirror or window.

The HMI 160 is a touch panel, a voice response device (an agent device), or the like. The HMI 160 receives various types of instructions from the occupant P to the mobile device 100, and provides various types of information to the occupant P.

The first control device 170 controls each part of the mobile device 100. The first control device 170 includes, for example, an acquisition unit 172, an extraction unit 174, and a communication control unit 176. These functional units, for example, are implemented by a processor such as a CPU executing a program (a group of instructions). Some or all of these constituent elements may be implemented by hardware (including a circuit unit; circuitry) such as an LSI circuit, an ASIC, an FPGA, a GPU, or an SOC, or may be implemented by software and hardware in cooperation.

The acquisition unit 172, for example, acquires voice data of the occupant P from the first microphone 120, acquires image data from the camera unit 130, and acquires position data of the mobile body M from the GNSS receiver 180. The image data includes an image of the inside of the mobile body M captured by the indoor camera 132 and an image of the outside of the mobile body M captured by the outdoor camera 134 (in other words, an image of scenery around the mobile body M).

When the acquired image data is the image of the scenery around the mobile body M, the extraction unit 174 extracts an extraction target object from the scenery image.

The extraction target object is one of the dynamic objects OBd and the static objects OBs predetermined as the extraction target. For example, the extraction target object is the dynamic object OBd. As described above, the dynamic object OBd is a pedestrian, another moving object, an animal such as a dog or a cat, a cloud drifting in the sky, a wave on the sea surface, or the like. The extraction target object is an example of a “first object.”

In addition, the extraction target object may be a static object OBs instead of a dynamic object OBd. Whether the dynamic object OBd or the static object OBs is the extraction target object may be optimally and automatically determined by the extraction unit 174 or may be manually determined by the user U.

For example, when the extraction target object is a dynamic object OBd, the extraction unit 174 cuts out the dynamic object OBd from the scenery image and extracts a partial area cut out from the scenery image as the extraction target object.

The communication control unit 176 may transmit various types of data acquired by the acquisition unit 172 to the user device 200 or the information processing device 300 via the first communication device 110. Moreover, when an extraction target object is extracted by the extraction unit 174, the communication control unit 176 may transmit the extracted extraction target object (a partial area of the scenery image) to the user device 200 or the information processing device 300 via the first communication device 110.

The GNSS receiver 180 identifies a position of the mobile body M on the basis of a signal received from a GNSS satellite. The position of the mobile body M may be identified or supplemented by an inertial navigation system (INS) using a speed and acceleration of the mobile body M and the like.

Control target equipment 190 is, for example, in-vehicle equipment such as a navigation device mounted on the mobile body M that guides the user along a route to a destination, or a driving assistance device that controls one or both of the steering and speed of the mobile body M to assist the occupant P in driving. The control target equipment 190 includes, for example, a seat drive device that can adjust a position (front, back, left, or right), a direction, and a height of the seat. When the user device 200 is used to view a video and the camera unit 130 of the mobile device 100 is attached to the seat, the seat movement can be prohibited to suppress an influence on the video. Moreover, even if the seat movement is permitted, a process such as view angle conversion may be performed so that a video is not influenced when the seat is moved. Moreover, if the user U desires to view a video outside a current view angle of the camera unit 130, the seat drive device may be controlled as a request from the user device 200 side.

FIG. 5 is a diagram showing an example of an arrangement of a part of the mobile device 100 in the mobile body M according to an embodiment. The indoor camera 132, for example, is attached to a neck pillow of the passenger seat S2 via an attachment 132A and is located slightly away from the backrest of the passenger seat S2 in a travel direction of the mobile body M. The indoor camera 132 has a wide-angle lens and can capture an image of a range indicated by an area 132B in FIG. 5. The indoor camera 132 can capture not only the inside of the mobile body M, but also the outside thereof through the window.

The outdoor camera 134 includes, for example, a plurality of outdoor sub-cameras 134-1 to 134-4. By combining images captured by the plurality of outdoor sub-cameras 134-1 to 134-4, an image such as a panoramic image of the outside of the mobile body M can be obtained. Instead of this (in addition to this), the outdoor camera 134 may include a wide-angle camera provided on the roof of the mobile body M. A camera capable of capturing an image of an area behind the passenger seat S2 may be added as the indoor camera 132, and a mobile body image to be described below may be generated as a 360-degree panoramic image by the first control device 170 by combining images captured by one or more indoor cameras 132, or may be generated as a 360-degree panoramic image by appropriately combining images captured by the indoor camera 132 and the outdoor camera 134.

The first speaker 140 outputs the voice of the user U acquired via the first communication device 110. The first speaker 140 includes, for example, a plurality of first sub-speakers 140-1 to 140-5. For example, the first sub-speaker 140-1 is arranged in the center of an instrument panel, the first sub-speaker 140-2 is arranged on the left end of the instrument panel, the first sub-speaker 140-3 is arranged on the right end of the instrument panel, the first sub-speaker 140-4 is arranged in the lower part of the left door, and the first sub-speaker 140-5 is arranged in the lower part of the right door. When the first control device 170 outputs the voice of the user U to the first speaker 140, for example, the first sub-speaker 140-2 and the first sub-speaker 140-4 are allowed to output the voice at approximately the same volume, and the other first sub-speakers are turned off, thereby localizing a sound image so that the voice can be heard from the passenger seat S2 by the occupant P seated in the driver’s seat S1. Moreover, a method of localizing the sound image is not limited to the volume adjustment, and may be performed by shifting the phase of the sound output from each of the first sub-speakers. For example, when a sound image is localized so that the sound is heard from the left side, it is only necessary for the timing of outputting the sound from the first sub-speaker on the left side to be slightly earlier than the timing of outputting the same sound from the first sub-speaker on the right side.

Moreover, when the voice of the user U is output to the first speaker 140, the first control device 170 may localize the sound image so that the voice is heard by the occupant P from a position at a height corresponding to the height of the head of the user U on the passenger seat S2 and output the voice uttered by the user U to the first speaker 140. In this case, the first speaker 140 needs to have a plurality of first sub-speakers 140-k (k is a plurality of natural numbers) at different heights.

### Configuration of user device

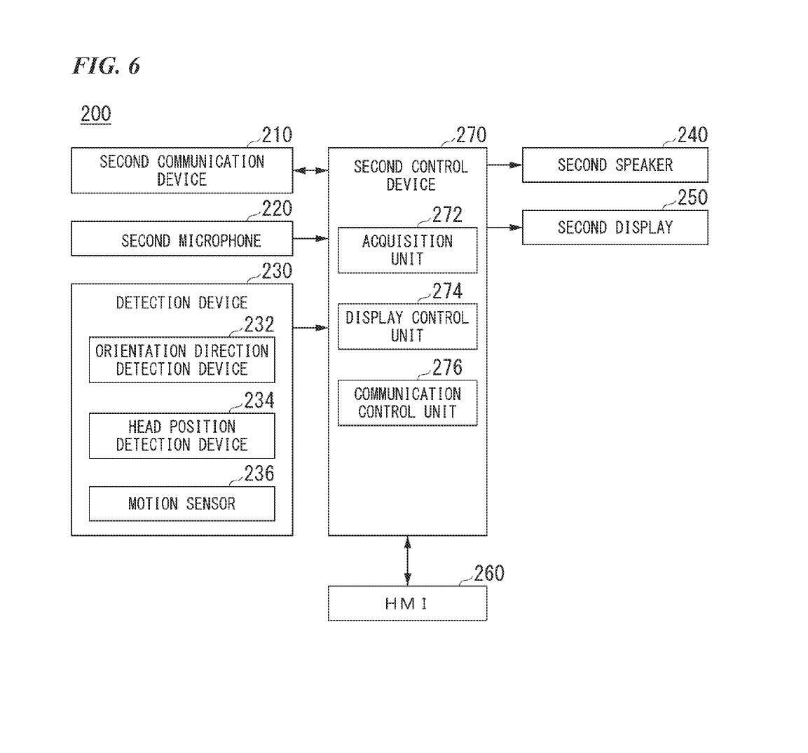

FIG. 6 is a diagram showing an example of a configuration of the user device 200 according to an embodiment. The user device 200 includes, for example, a second communication device 210, a second microphone 220, a detection device 230, a second speaker 240, a second display 250, an HMI 260, and a second control device 270.

The second communication device 210 is a communication interface for communicating with each of the third communication device 310 of the information processing device 300 and the first communication device 110 of the mobile device 100 via the network NW.

The second microphone 220 collects voice uttered by the user U. The second communication device 210 transmits the voice collected by the second microphone 220 to the first communication device 110, for example, via the second control device 270.

The detection device 230 includes, for example, an orientation direction detection device 232, a head position detection device 234, and a motion sensor 236. The detection device 230 is an example of an “input interface.”

The orientation direction detection device 232 is a device for detecting an orientation direction. The orientation direction is based on a direction of the user U’s face or a visual line direction, or both. Hereinafter, the orientation direction is an angle within a horizontal plane, i.e., an angle that does not have an upward or downward component, but the orientation direction may also be an angle that includes an upward or downward component. The orientation direction detection device 232 may include a physical sensor (e.g., an acceleration sensor, a gyro sensor, or the like) attached to the VR goggles to be described below, or may be an infrared sensor that detects a plurality of positions of the user U’s head, or a camera that captures the user U’s head. In either case, the second control device 270 calculates the orientation direction based on the information input from the orientation direction detection device 232. Because various technologies for this are publicly known, detailed description will be omitted.

The head position detection device 234 is a device for detecting the position (height) of the head of the user U. For example, one or more infrared sensors or optical sensors installed around a chair in which the user U sits are used as the head position detection device 234. In this case, the second control device 270 detects the position of the head of the user U on the basis of the presence or absence of detection signals from one or more infrared sensors or optical sensors. Moreover, the head position detection device 234 may be an acceleration sensor attached to the VR goggles. In this case, the second control device 270 detects the position of the head of the user U by integrating values obtained by subtracting the gravitational acceleration from the output of the acceleration sensor. The head position information acquired as described above is provided to the second control device 270 as height information. The user’s head position may be acquired on the basis of the user U’s operation on the HMI 260. For example, the user U may input his/her height into the HMI 260 in numbers, or may input his/her height using a dial switch included in the HMI 260. In these cases, the head position, i.e., height information, is calculated from the height. Moreover, the user U may input discrete values such as physical build: large/medium/small to the HMI 260 instead of continuous values. In this case, the height information is acquired on the basis of information indicating the physical build. Moreover, the head height of the user is not acquired in particular and the head height of the user U may be acquired simply on the basis of the physical build of a general adult (which may be gender-specific).

The motion sensor 236 is a device for recognizing gesture operations performed by the user U. For example, a camera that captures an upper body of the user U is used as the motion sensor 236. In this case, the second control device extracts feature points (fingertips, wrists, elbows, and the like) of the user U’s body from the image captured by the camera, and recognizes the gesture operations of the user U on the basis of the movement of the feature points.

The second speaker 240 outputs the voice of the occupant P acquired via the second communication device 210. The second speaker 240, for example, has a function of changing a direction in which the voice is heard. The second control device 270 causes the second speaker to output the voice so that the user U can hear the voice from the position of the occupant P as seen from the passenger seat S2. The second speaker 240 includes a plurality of second sub-speakers 240-n (n is a plurality of natural numbers) and the second control device 270 may adjust the volume of each second sub-speaker 240-n to perform sound image localization or the function of the headphones may be used to perform sound image localization when headphones are attached to the VR goggles.

The second display 250 displays an image captured by the camera unit 130 (which may be an image that has been subjected to the above-described combining process, and is hereinafter referred to as a mobile body image). Moreover, the second display 250 may display an image of a specific orientation direction among the mobile body images.

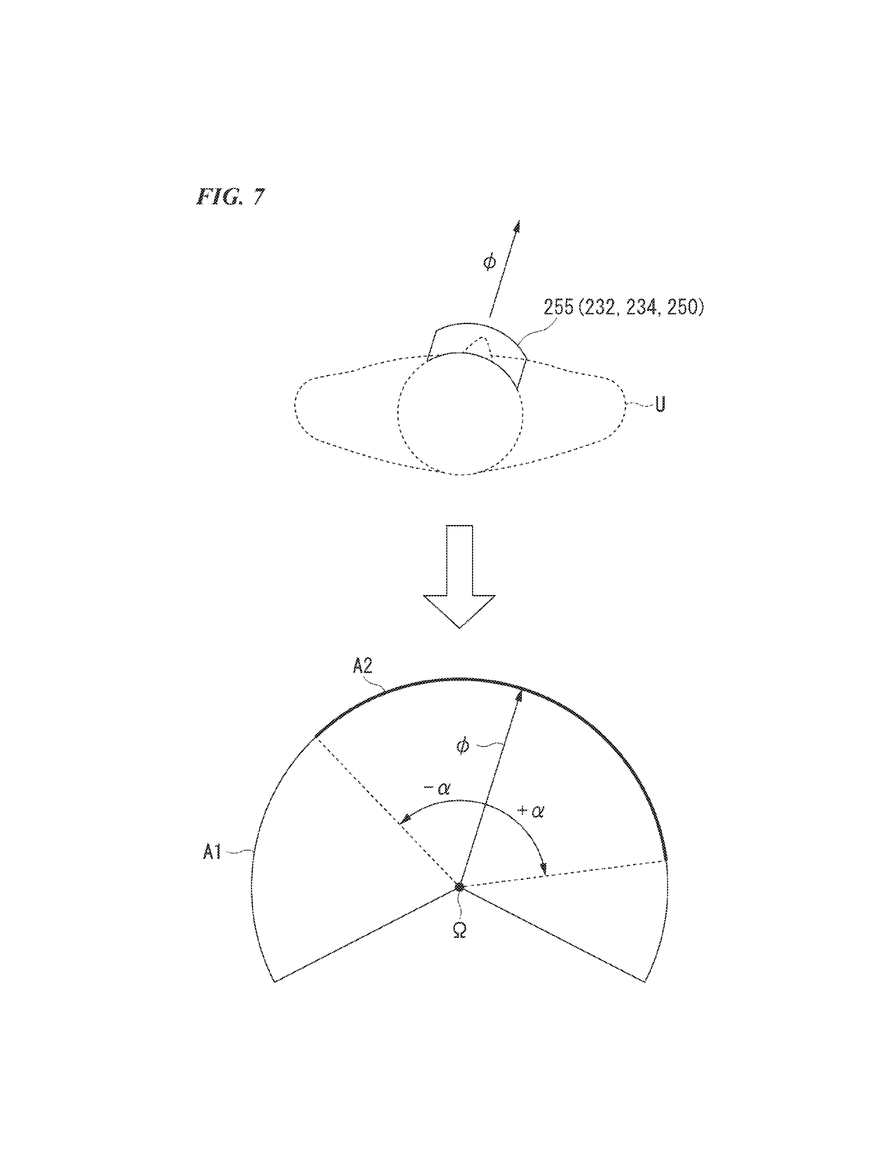

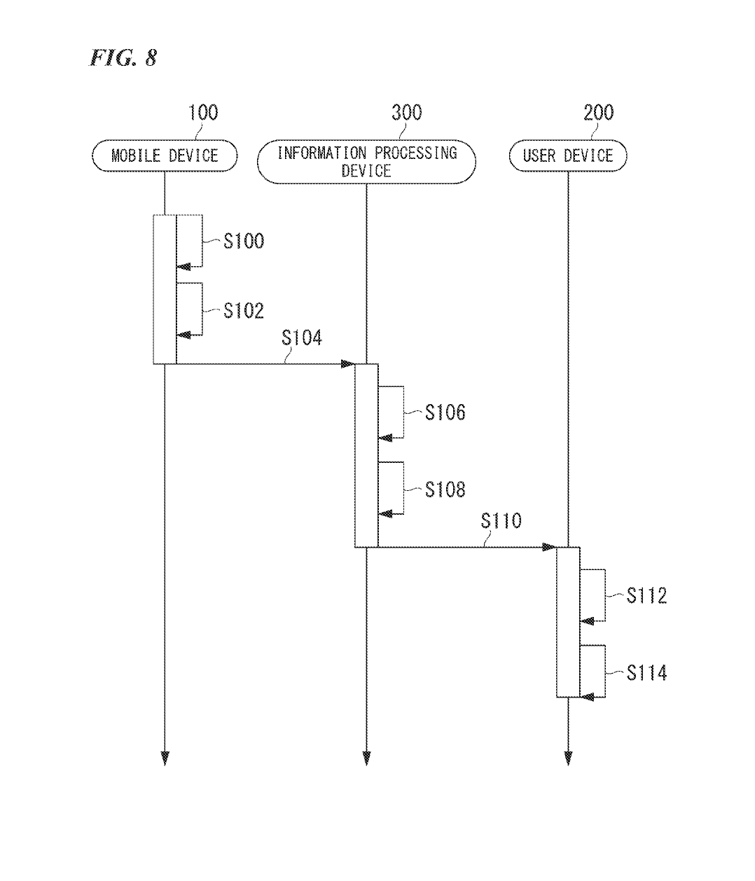

FIG. 7 is an explanatory diagram of an image corresponding to an orientation direction. In the example of FIG. 7, VR goggles 255 include an orientation direction detection device 232, a physical sensor serving as a head position detection device 234, and a second display 250. The second control device 270, for example, detects a direction in which the VR goggles 255 faces as the orientation direction φ by setting the center of the user U’s head or the center of the VR goggles 255 as Ω and setting a pre-calibrated direction as a reference direction. Because various methods for this function are already known, detailed description will be omitted.

The second display 250 displays an image A2 of the mobile body image A1 within an angle range of positive or negative α centered on the orientation direction φ toward the user U. The mobile body image A1 has an angle of approximately 240 degrees in the drawing, but the angle of view may be expanded by the combining process as described above.

The HMI 260 is a touch panel, a voice response device (agent device), the above-described switch, or the like. The HMI 260 receives various types of instructions from the user U to the user device 200. The HMI 260 is another example of an “input interface.”

The second control device 270 controls each part of the user device 200. The second control device 270 includes, for example, an acquisition unit 272, a display control unit 274, and a communication control unit 276. These functional units, for example, are implemented by a processor such as a CPU executing a program (a group of instructions). Some or all of these constituent elements may be implemented by hardware (including a circuit unit; circuitry) such as an LSI circuit, an ASIC, an FPGA, a GPU, or an SOC, or may be implemented by software and hardware in cooperation. The user device 200 may be configured so that all of the functions shown in FIG. 6 are integrated into the VR goggles.

The acquisition unit 272, for example, acquires voice data of the user U from the second microphone 220, and acquires detection data indicating a detection result from the detection device 230. Moreover, the acquisition unit 272 may acquire various types of information and data from the mobile device 100 and the information processing device 300 via the second communication device 210.

The display control unit 274 causes the second display 250 to display a mobile body image.

The communication control unit 276 transmits various types of data acquired by the acquisition unit 272 to the mobile device 100 and the information processing device 300 via the second communication device 210.

### Sequence of information processing system

FIG. 8 is a sequence diagram showing a flow of a series of processing steps in the information processing system 1 according to the embodiment.

First, the acquisition unit 172 of the mobile device 100 acquires an image of scenery around the mobile body M from the outdoor camera 134 and acquires the position information (latitude and longitude) of the mobile body M at the time when the scenery image has been captured from the GNSS receiver 180 (step S100).

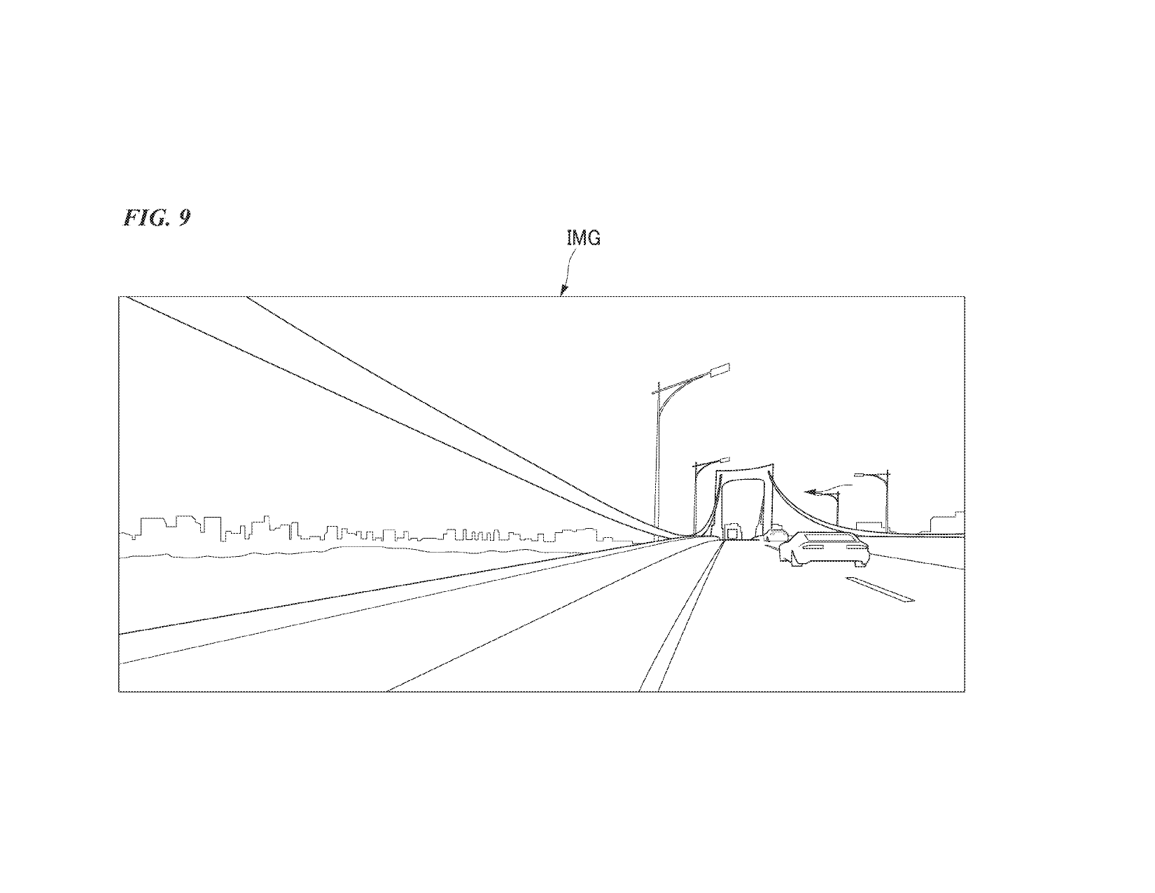

FIG. 9 is a diagram showing an example of a scenery image. In FIG. 9, IMG denotes a scenery image, and this scenery image represents a scenery image (IMG in FIG. 9) when the mobile body M is traveling on a road laid on a bridge. Such a scenery image may include other mobile devices traveling around the mobile body M, bridge structures (a main tower, a main cable, and a hanger rope), and the like.

Subsequently, the extraction unit 174 of the mobile device 100 extracts an extraction target object (e.g., a dynamic object OBd) from the scenery image (step S102).

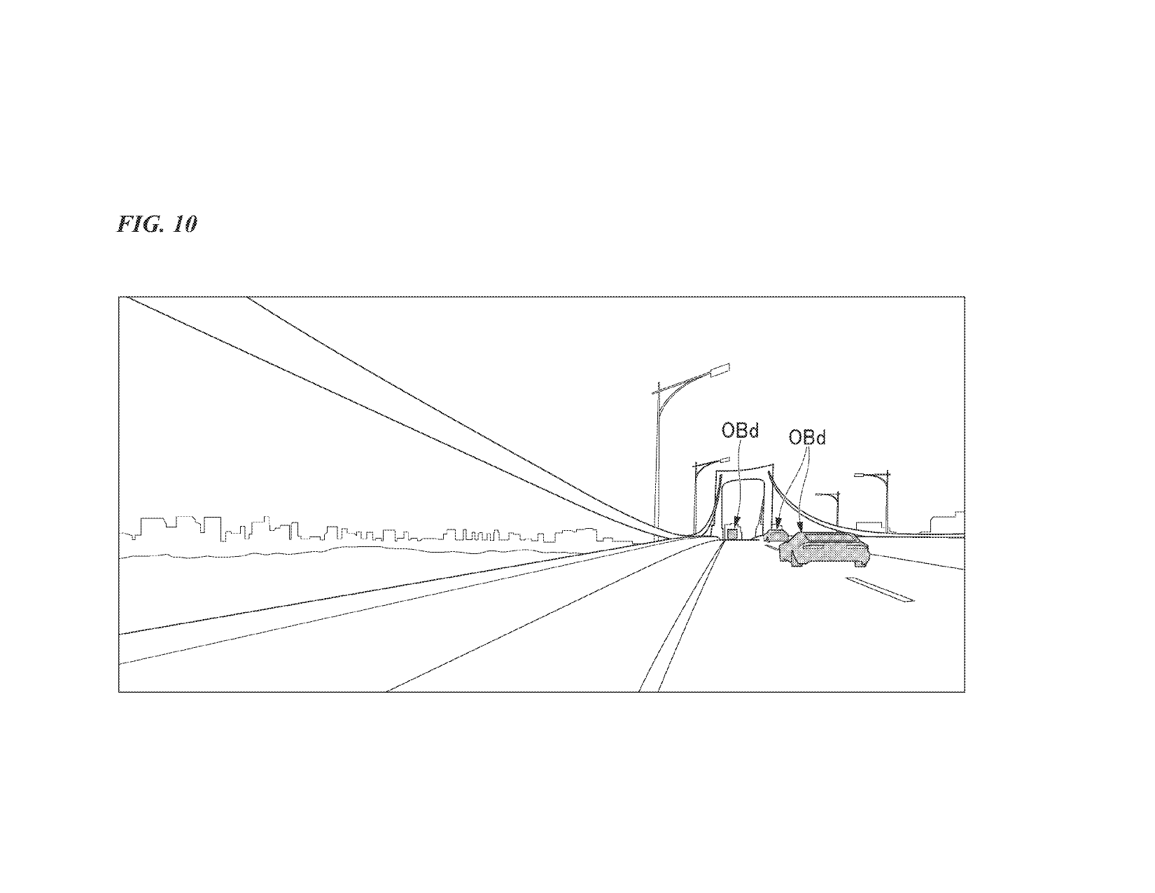

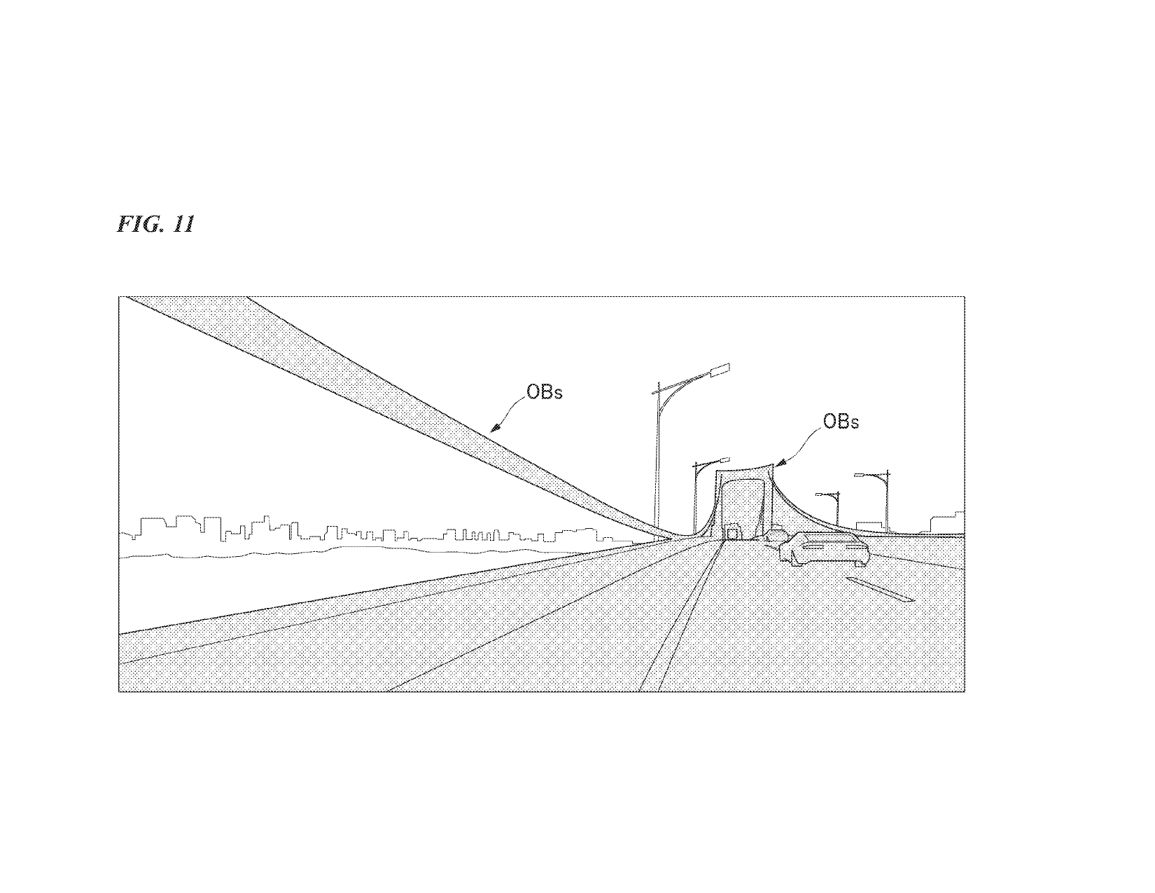

FIG. 10 is a diagram showing an example of a dynamic object OBd. For example, when the extraction target object is the dynamic object OBd, the extraction unit 174 cuts out other mobile bodies (adjacent vehicles and preceding vehicles) that appear in the scenery image from the scenery image, and extracts these other mobile bodies that have been cut out as extraction target objects.

Subsequently, the communication control unit 176 of the mobile device 100 transmits the extraction target object extracted from the scenery image with the extraction unit 174 and the position information of the mobile body M at the time when the scenery image has been captured to the information processing device 300 via the first communication device 110 (step S104).

Subsequently, the third communication device 310 of the information processing device 300 receives the extraction target object and the position information of the mobile body M from the mobile device 100 (step S106). Furthermore, the acquisition unit 321 acquires the extraction target object and the position information of the mobile body M from the third communication device 310.

Subsequently, the generation unit 323 of the information processing device 300 generates an image in which the extraction target object is superimposed on a non-extraction-target object (hereinafter referred to as a superimposed image) (step S108).

The non-extraction-target object is the other object that is not the extraction target object between the dynamic object OBd and the static object OBs. For example, when the extraction target object is the dynamic object OBd, the non-extraction-target object is a static object OBs.

For example, the generation unit 323 reads a static object OBs corresponding to the position information of the mobile body M from among a plurality of static objects OBs stored in the storage unit 350 as the provision information DB 362. As shown in the example of FIG. 3, a plurality of static objects OBs associated with coordinates are stored in the storage unit 350 as the provision information DB 362. For example, if the position of the mobile body M when the scenery image has been captured is exactly “AAA,” the generation unit 323 reads the static object OBs related to the “bridge” associated with the coordinates “AAA” from the storage unit 350.

FIG. 11 is a diagram showing an example of the static object OBs. As shown in FIG. 11, a tower, a main cable, a hanger rope, and the like are extracted from the scenery image of the “bridge,” and these are stored in the storage unit 350 as the static object OBs related to the “bridge.”

Also, the generation unit 323 superimposes the dynamic object OBd extracted as the extraction target object on the static object OBs called “bridge.” In this way, a superimposed image is generated. The superimposed image may be a 360-degree panoramic image.

Subsequently, the communication control unit 325 transmits the superimposed image to the user device 200 via the third communication device 310 (step S110).

Subsequently, the second communication device 210 of the user device 200 receives the superimposed image from the information processing device 300 (step S112). Furthermore, the acquisition unit 272 acquires the superimposed image from the second communication device 210.

Subsequently, the display control unit 274 of the user device 200 causes the second display 250 to display the superimposed image (step S114). Thereby, the series of processing steps ends.

### General overview

According to the above-described embodiment, the mobile device 100 (an example of a “first device”) captures an image of scenery around the mobile body M, and extracts an extraction target object (an example of a “first object”), which is at least one of the dynamic object OBd and the static object OBs, from a scenery image. Also, the mobile device 100 transmits the extraction target object to the information processing device 300 (an example of a “second device”).

The information processing device 300 receives the extraction target object transmitted from the mobile device 100 and reads the non-extraction-target object, which is the other of the dynamic objects OBd and the static objects OBs that are not the extraction target object, from the storage unit 350. The information processing device 300 generates a superimposed image in which the extraction target object is superimposed on the read non-extraction-target object. Also, the information processing device 300 transmits the superimposed image to the user device 200 (an example of a “third device”). In this way, when a scenery image is transmitted from the mobile device 100 to the information processing device 300, a low-latency, high-quality image can be provided to the user U by transmitting a partial area of the scenery image without transmitting the entire area of the scenery image. As a result, the sense of immersion, satisfaction, and realism of the user U viewing the scenery image and the like can be improved.

### Other embodiments (modified examples)

Hereinafter, other embodiments will be described. Although the case where the extraction target object is a dynamic object OBd (e.g., a pedestrian or another mobile body) and the non-extraction-target object is a static object OBs (e.g., a bridge or a building) has been described in the above-described embodiment, the present invention is not limited thereto. For example, the extraction target object may be a static object OBs and the non-extraction-target object may be a dynamic object OBd. In other words, the object (a part area of the scenery image) transmitted from the mobile device 100 to the information processing device 300 may be a static object OBs such as a bridge or a building. In this case, the storage unit 350 stores a plurality of dynamic objects OBd associated with coordinates as the provision information DB 362.

Although a case where the scenery image from which the extraction target object is extracted is captured in real time by the camera unit 130 while the mobile body M is moving has been described in the above-described embodiment, the present invention is not limited thereto. For example, the scenery image from which the extraction target object is extracted may be an image previously captured by the camera unit 130 when the mobile body M was moving, i.e., a past scenery image that is not in real time.

Moreover, the scenery image from which the extraction target object is extracted may be a three-dimensional map image provided by a three-dimensional map service.

Although the case where a process in which the dynamic object OBd or the static object OBs is the extraction target object is predetermined has been described in the above-described embodiment, the present invention is not limited thereto. For example, which of the dynamic object OBd and the static object OBs is the extraction target object may be dynamically changed in accordance with the user U’s preference.

For example, the user U may use the HMI 260 to select which of the dynamic object OBd and the static object OBs is the extraction target object. Moreover, the user U may wear VR goggles and stare at the object that he or she wants to set as the extraction target object, thereby selecting the object serving as the extraction target object. Moreover, the user U may wear the VR goggles and make a gesture to select the object serving as the extraction target object.

In this case, the communication control unit 276 of the user device 200 transmits the selection result of the object input to the HMI 260 to the information processing device 300 via the second communication device 210, and transmits a result of an action of the user U detected by the detection device 230 to the information processing device 300 via the second communication device 210. In response to this, the third control device 320 of the information processing device 300 may decide one of the dynamic object OBd and the static object OBs selected by the user U as the extraction target object.

Although the case where a superimposed image in which the dynamic object OBd that is an extraction target object is superimposed on the static object OBs that is a non-extraction-target object is generated or the case where a superimposed image in which the static object OBs that is an extraction target object is superimposed on the dynamic object OBd that is a non-extraction-target object is generated has been described in the above-described embodiment, the present invention is not limited thereto.

For example, the generation unit 323 may generate a superimposed image by superimposing a third object on a static object OBs that is a non-extraction-target object, in addition to or instead of superimposing a dynamic object OBd that is an extraction target object on a static object OBs that is a non-extraction-target object.

Likewise, the generation unit 323 may generate a superimposed image by superimposing a third object on a dynamic object OBd that is a non-extraction-target object in addition to or instead of superimposing a static object OBs that is an extraction target object on a dynamic object OBd that is a non-extraction-target object.

The third object may include a fictional object (such as a virtual advertisement or a virtual creature), an object included in scenery captured at a location other than the location where the scenery has been captured (e.g., such as a planet or constellation that exists in outer space captured in space), an object extracted from an image of historical scenery (such as an ancient building), and the like.

Although modes for carrying out the present invention have been described using embodiments, the present invention is not limited to the embodiments and various modifications and substitutions can be made without departing from the scope and spirit of the present invention.

What is claimed is:

1. An information processing system comprising:
a first device mounted on a mobile body; and
a second device configured to communicate with the first device,
wherein the first device includes
a camera configured to capture an image of scenery around the mobile body,
an extraction unit configured to extract a first object, which is at least one of a dynamic object and a static object, from the image of the scenery captured by the camera, and
a transmission unit configured to transmit the first object to the second device, and
wherein the second device includes
a reception unit configured to receive the first object transmitted from the first device, and
a generation unit configured to read the second object, which is the other of the dynamic object and the static object that is not the first object, from a storage unit in which the second object is stored in advance and generate a superimposed image that is an image in which the first object is superimposed on the read second object.

2. The information processing system according to claim 1, wherein a previously captured image of the scenery is included in the image from which the first object is extracted.

3. The information processing system according to claim 1, wherein a three-dimensional map image provided by a three-dimensional map service is included in the image from which the first object is extracted.

4. The information processing system according to claim 1, further comprising a third device configured to communicate with the second device,
wherein the third device has an input interface operated by a user, and
wherein the extraction unit extracts one of the dynamic object and the static object selected by the user via the input interface as the first object from the image.

5. The information processing system according to claim 1,
wherein the generation unit generates an image in which a third object is superimposed on the read second object as the superimposed image, and
wherein a fictional object, an object captured at a location different from the scenery, or an object extracted from a previously captured image of the scenery is included in the third object.

6. An information processing method using an information processing system including a first device mounted on a mobile body and a second device configured to communicate with the first device, the information processing method comprising:
capturing, by the first device, an image of the scenery around the mobile body;
extracting, by the first device, a first object, which is at least one of a dynamic object and a static object, from the captured image of the scenery;
transmitting, by the first device, the first object to the second device;
receiving, by the second device, the first object transmitted from the first device;
reading, by the second device, a second object, which is the other of the dynamic object and the static object that is not the first object, from a storage unit in which the second object is stored in advance; and
generating, by the second device, a superimposed image that is an image in which the first object is superimposed on the read second object.

7. A non-transitory storage medium storing a program to be executed by a computer of each of a first device mounted on a mobile body and a second device configured to communicate with the first device,
wherein the program includes
capturing an image of the scenery around the mobile body;
extracting a first object, which is at least one of a dynamic object and a static object, from the captured image of the scenery;
transmitting the first object to the second device;
receiving the first object transmitted from the first device;
reading a second object, which is the other of the dynamic object and the static object that is not the first object, from a storage unit in which the second object is stored in advance; and
generating a superimposed image that an image in which the first object is superimposed on the read second object.
